(19) United States
(12) Patent Application Publication
(10) Pub. No.: US 2026/0246303 A1
(43) Pub. Date: Aug. 20, 2026

(54) WIRELESS POWER SUPPLY SYSTEM, WIRELESS POWER SUPPLY DEVICE, CONTROL DEVICE, VEHICLE, AND WIRELESS POWER SUPPLY METHOD

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP); Kanazawa Institute of Technology, Nonoichi-shi, Ishikawa (JP)

(72) Inventors: Toyohisa TAKANO, Osaka-shi, Osaka (JP); Suguru YAMAGISHI, Osaka-shi, Osaka (JP); Ichiro KUWAYAMA, Osaka-shi, Osaka (JP); Yasuyuki YAMAMOTO, Osaka-shi, Osaka (JP); Kenji ITO, Nonoichi-shi, Ishikawa (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP); Kanazawa Institute of Technology, Nonoichi-shi, Ishikawa (JP)

(21) Appl. No.: 19/469,522

(22) PCT Filed: Mar. 19, 2024
(86) PCT No.: PCT/JP2024/010847

§ 371 Date: Sep. 26, 2025

(30) Foreign Application Priority Data
Mar. 29, 2023 (JP) 2023-052875

(51) Int. Cl. H02J 50/20; B60L 53/12; H02J 50/70; H02J 50/80

(52) U.S. Cl. CPC H02J 50/20; B60L 53/12; H02J 50/70; H02J 50/80

(57) ABSTRACT

A wireless feeding system includes: a power receiving device disposed in a vehicle; and a feeding device configured to feed power through a radio wave to the power receiving device. The feeding device includes: a power transmission unit disposed in the vehicle and configured to transmit the radio wave; and a control unit configured to control the power transmission unit. The control unit includes: a reception unit configured to receive information regarding the vehicle; and a processing unit configured to execute a first control process of restricting transmission of the radio wave, when having determined that the information satisfies a predetermined condition.

### CROSS-REFERENCE TO RELATED APPLICATIONS

This application is the U.S. national stage of PCT/JP 2024/010847 filed on Mar. 19, 2024, which claims priority of Japanese Patent Application No. JP 2023-052875 filed on Mar. 29, 2023, the contents of which are incorporated herein.

### TECHNICAL FIELD

The present disclosure relates to a wireless feeding system, a wireless feeding device, a control device, a vehicle, and a wireless feeding method.

### BACKGROUND

In recent years, in a vehicle such as a passenger car, in order to improve cabin comfort in the vehicle, a sensor that detects a physical quantity such as temperature in the vehicle may be disposed.

Connecting such a sensor and a control device in a wired manner may cause increase in costs and increase in weight.

Therefore, it is considered to wirelessly connect the sensor and the control device. In order to wirelessly connect the sensor and the control device, wireless feeding to the sensor is required.

For example, Japanese Laid-open Patent Publication No. 2011-525098 discloses a technology regarding a wireless feeding system that transfers power through transmission and reception of a radio wave.

The radio wave for feeding in the wireless feeding system described above has larger transmitting power as compared with a radio wave for wireless LAN communication or the like.

Therefore, if the radio wave for feeding has leaked from the inside of a vehicle to the outside of the vehicle, the leaked radio wave may become a disturbance wave to an external device, such as ETC or a radio telescope, that uses a radio wave, a facility in which a device using a radio wave is installed, and the like, or may become an interference wave to the device, the facility, and the like.

Therefore, depending on the situation around the vehicle, the open or closed state of a door of the vehicle, and the like, there is a possibility that the radio wave for feeding influences an external device and a facility.

Therefore, an object of the present disclosure is to provide a technology that can inhibit the radio wave for feeding from influencing an external device, a facility, and the like.

### SUMMARY

A wireless feeding system, which is an embodiment, includes: a power receiving device disposed in a vehicle; and a feeding device configured to feed power through a radio wave to the power receiving device. The feeding device includes: a power transmission unit disposed in the vehicle and configured to transmit the radio wave; and a control unit configured to control the power transmission unit. The control unit includes: a reception unit configured to receive information regarding the vehicle; and a processing unit configured to execute a first control process of restricting transmission of the radio wave, when having determined that the information satisfies a predetermined condition.

### Effects of the Present Disclosure

According to the present disclosure, it is possible to inhibit the radio wave for feeding from influencing an external device, a facility, and the like.

### BRIEF DESCRIPTION OF DRAWINGS

FIG. 1 is a side view showing an example of a vehicle according to a first embodiment.

FIG. 2 is a cross-sectional view showing an example of a window glass.

FIG. 3 shows a relationship between a wireless feeding system and components of the vehicle.

FIG. 4 is a block diagram showing a configuration example of a sensor device.

FIG. 5 is a block diagram showing a configuration example of a feeding device.

FIG. 6 is a flowchart showing an example of a feeding control process executed by a processing unit.

FIG. 7 is a block diagram of the sensor device according to a second embodiment.

FIG. 8 shows a relationship between the wireless feeding system and components of the vehicle according to the second embodiment.

FIG. 9 is a flowchart showing the feeding control process executed by the processing unit according to the second embodiment.

### DETAILED DESCRIPTION OF PREFERRED EMBODIMENTS

First, contents of embodiments are listed and described.

In a first aspect, a wireless feeding system according to an embodiment of the present disclosure includes: a power receiving device disposed in a vehicle; and a feeding device configured to feed power through a radio wave to the power receiving device. The feeding device includes: a power transmission unit disposed in the vehicle and configured to transmit the radio wave; and a control unit configured to control the power transmission unit. The control unit includes: a reception unit configured to receive information regarding the vehicle; and a processing unit configured to execute a first control process of restricting transmission of the radio wave, when having determined that the information satisfies a predetermined condition.

According to the above configuration, when it has been determined that the information regarding the vehicle satisfies the predetermined condition, transmission of the radio wave by the power transmission unit is restricted. Therefore, if the predetermined condition is appropriately set, when there is a possibility that the radio wave of the power transmission unit leaks to the outside of the vehicle or causes interference, disturbance, and the like to an external device, a facility, and the like, transmission of the radio wave can be restricted.

As a result, it is possible to inhibit the radio wave for feeding from influencing an external device, a facility, and the like.

In a second aspect, in the wireless feeding system according to the first aspect, the information may include position information of the vehicle.

In this case, the predetermined condition can include restriction regarding the position of the vehicle.

In a third aspect, in the wireless feeding system according to the second aspect, the predetermined condition may include that a position of the vehicle indicated by the position information is in a specific area set in advance.

Here, when the specific area is set to an area where there is a possibility that the radio wave for feeding causes interference, disturbance, and the like to an external device, a facility, and the like, it is possible to restrict transmission of the radio wave when the vehicle is at a position in the area where there is a possibility that the vehicle causes interference, disturbance, and the like. Accordingly, it is possible to inhibit the radio wave for feeding from influencing an external device, a facility, and the like.

In a fourth aspect, in the wireless feeding system according to any one of the first to the third aspects, when the vehicle includes a body part that has: a plurality of panels each composed of a conductor; and a window glass including a glass part and a shielding member configured to block the radio wave, the information may include at least one of window information indicating an open or closed state of the window glass, and door information indicating an open or closed state of a door of the vehicle.

In this case, the predetermined condition can include at least one of restriction regarding the open or closed state of the window glass, and restriction regarding the open or closed state of the door.

In a fifth aspect, in the wireless feeding system according to the fourth aspect, the predetermined condition includes that the window information and the door information indicate that at least one of the window glass and the door is in an open state.

In this case, since the window glass has the shielding member blocking the radio wave, if the window glass is in the closed state and the door is in the closed state, leakage of the radio wave of the feeding device to the outside of the vehicle can be inhibited.

Meanwhile, when there is a possibility that the radio wave of the feeding device leaks to the outside of the vehicle since the window glass or the door of the vehicle is in the open state, transmission of the radio wave can be restricted.

Accordingly, it is possible to inhibit the radio wave for feeding from influencing an external device, a facility, and the like.

In a sixth aspect, in the wireless feeding system according to any one of the first to the fifth aspects, the processing unit may be configured to further execute an output process of outputting information indicating that transmission of the radio wave is restricted when the information satisfies the predetermined condition.

In this case, it is possible to notify an occupant of the vehicle that transmission of the radio wave is to be restricted.

In a seventh aspect, in the wireless feeding system according to any one of the first to the sixth aspects, the processing unit may: when having determined that the information does not satisfy the predetermined condition, determine whether or not transmission of the radio wave is being restricted; when having determined that transmission of the radio wave is not being restricted, transmit the radio wave at first transmission power larger than transmission power of the radio wave restricted by the first control process; and when having determined that transmission of the radio wave is being restricted, further execute a second control process of transmitting the radio wave at second transmission power larger than the first transmission power to cancel restriction of transmission of the radio wave.

In this case, after transmission of the radio wave has been restricted, when there is no longer a possibility that the radio wave of the feeding device leaks to the outside of the vehicle or causes interference, disturbance, and the like to an external device, a facility, and the like, feeding can be performed at the second transmission power larger than the first transmission power. As a result, supply power to the power receiving device having decreased due to restriction of transmission of the radio wave can be supplemented.

That is, when the power receiving device includes a storage battery and the first transmission power is set to power at which the storage battery can be maintained in an appropriate storage state, if feeding is performed at the second transmission power larger than the first transmission power, the storage state of the storage battery having decreased due to the restriction of transmission of the radio wave can be quickly recovered to an appropriate state.

In an eighth aspect, in the wireless feeding system according to the seventh aspect, when the power receiving device includes a storage battery configured to store transmission power from the feeding device, and a transmitting unit configured to transmit power storage information indicating a storage state of the storage battery, the reception unit of the feeding device may further receive the power storage information, and in the second control process, the second transmission power may be adjusted based on the power storage information.

In this case, since the second transmission power is adjusted based on the power storage information, feeding can be appropriately performed in accordance with the storage state of the storage battery.

In a ninth aspect, in the wireless feeding system according to the eighth aspect, when the power receiving device further includes a sensor configured to detect a physical quantity in the vehicle, the transmitting unit may transmit output information of the sensor together with the power storage information to the vehicle, and the reception unit may receive the power storage information provided from the vehicle.

In this case, the transmitting unit transmits the power storage information and the output information of the sensor to the vehicle. Therefore, it is not necessary to prepare a plurality of transmission devices for transmitting pieces of information, whereby a simple configuration can be realized.

An embodiment from another viewpoint is a wireless feeding device configured to feed power through a radio wave to a power receiving device disposed in a vehicle. This wireless feeding device includes: a power transmission unit disposed in the vehicle and configured to transmit the radio wave; and a control unit configured to control the power transmission unit. The control unit includes: a reception unit configured to receive information regarding the vehicle; and a processing unit configured to execute a first control process of restricting transmission of the radio wave, when having determined that the information satisfies a predetermined condition.

An embodiment from another viewpoint is a control device configured to control a power transmission unit of a wireless feeding device configured to feed power through a radio wave to a power receiving device disposed in a vehicle. This control device includes: a reception unit configured to receive information regarding the vehicle; and a processing unit configured to execute a first control process of restricting transmission of the radio wave, when having determined that the information satisfies a predetermined condition.

An embodiment from still another viewpoint is a vehicle. This vehicle includes: a vehicle body; a power receiving device disposed in the vehicle body; and a feeding device configured to feed power through a radio wave to the power receiving device. The feeding device includes: a power transmission unit disposed in the vehicle and configured to transmit the radio wave; and a control unit configured to control the power transmission unit. The control unit includes: a reception unit configured to receive information regarding the vehicle; and a processing unit configured to execute a first control process of restricting transmission of the radio wave, when having determined that the information satisfies a predetermined condition.

An embodiment from another viewpoint is a wireless feeding method for feeding power through a radio wave to a power receiving device disposed in a vehicle. This wireless feeding method includes the steps of: receiving information regarding the vehicle; and restricting transmission of the radio wave, when having determined that the information satisfies a predetermined condition.

Hereinafter, preferred embodiments will be described with reference to the drawings.

At least some parts of the embodiments described below may be combined as desired.

### Overall Configuration of First Embodiment

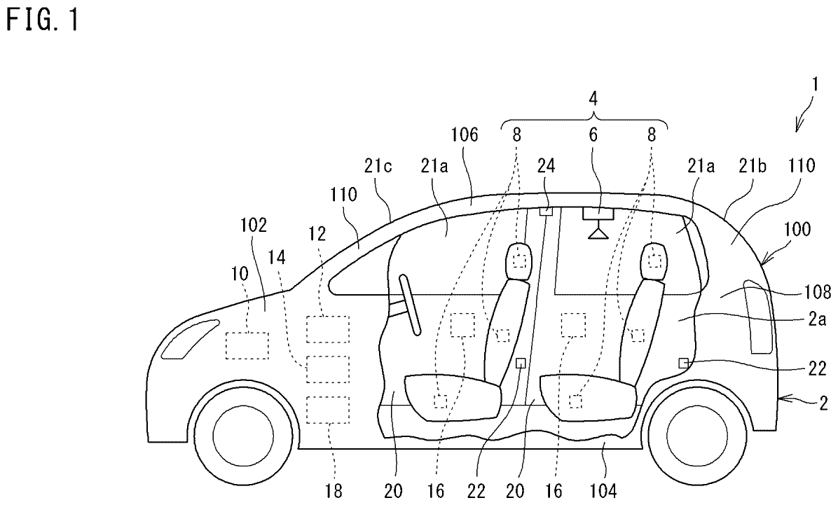

FIG. 1 is a side view showing an example of a vehicle according to a first embodiment. FIG. 1 shows the inside of a cabin 2a with a part of a vehicle 1 cut off.

In FIG. 1, the vehicle 1 is a vehicle (passenger car) including an electric vehicle, an internal combustion engine vehicle, a hybrid vehicle, and the like.

The vehicle 1 has a vehicle body 2 and a wireless feeding system 4.

The wireless feeding system 4 is a power transfer system of a spatial transfer type that transfers power through transmission and reception of a radio wave.

The wireless feeding system 4 has a feeding device 6 and a plurality of sensor devices 8.

The feeding device 6 is installed at a ceiling surface in the cabin 2a. The feeding device 6 performs wireless feeding to the plurality of sensor devices 8 by transmitting a radio wave.

The plurality of sensor devices 8 are provided to seats in the cabin 2a. The plurality of sensor devices 8 each include a temperature-sensitive element, and measure partial temperature in the cabin 2a. The plurality of sensor devices 8 each wirelessly transmit information indicating a measurement result to an ECU 12 of the vehicle body 2.

The plurality of sensor devices 8 each have a function of receiving the radio wave from the feeding device 6 to be wirelessly fed with power. That is, the plurality of sensor devices 8 each have a function as a power receiving device.

The plurality of sensor devices 8 are each configured to operate using the power wirelessly fed from the feeding device 6. Therefore, the plurality of sensor devices 8 are each fed with power without being connected with another external device in a wired manner, and operate.

The vehicle body 2 has a body part 100, a power supply 10, the ECU (Electronic Control unit) 12, and a GPS (Global Positioning System) receiver 14.

The body part 100 includes: a front panel 102 including a hood, a front inner panel, and the like; a floor panel 104; a roof 106; a rear panel 108 including a rear trunk, a rear inner panel, and the like; a plurality of pillars 110; a plurality of doors 20; a plurality of window glasses 21; and the like. The front panel 102, the floor panel 104, the roof 106, the rear panel 108, and the plurality of pillars 110 are formed mainly from a conductor such as a steel plate or an aluminum alloy plate.

Further, the body part 100 has openings such as an entry opening, a front window, and a rear window.

The plurality of doors 20 are formed from a conductor such as a steel plate or an aluminum alloy plate, excluding the window glasses 21. The plurality of doors 20 are provided at the entry openings so as to be openable and closable.

The plurality of window glasses 21 include a front glass 21c, a rear glass 21b, and a door glass 21a.

The rear glass 21b closes the rear window. The front glass 21c closes the front window. The door glass 21a closes the door window of each door 20.

The cabin 2a is provided inside the body part 100. The cabin 2a is a closed space defined by each panel, the doors 20, and the plurality of window glasses 21.

The conductor portions of the body part 100 such as the panels, the pillars, and the doors may be made of resin including a radio wave shielding member.

In the present embodiment, it is assumed that the conductor portions of the body part 100 such as the panels, the pillars, and the doors are formed from a steel plate.

The power supply 10 is a secondary battery, for example, including a lead storage battery, a lithium ion battery, a nickel hydrogen battery, or the like, as well as a capacitor, and the like.

The ECU 12 has a function of performing processes regarding control of components of the vehicle body 2.

The GPS receiver 14 receives radio waves from a plurality of GPS satellites, and obtains position information indicating the present position of the vehicle 1. The GPS receiver 14 may be included in a car navigation system mounted on the vehicle body 2, or the GPS receiver 14 alone may be mounted on the vehicle body 2.

The vehicle body 2 has a plurality of power window devices 16 and a power window ECU 18.

The plurality of power window devices 16 are provided to the plurality of doors 20, respectively. Each power window device 16 is a device for causing the door glass 21a of a corresponding door 20 to perform open-and-close operation.

The power window ECU 18 controls the plurality of power window devices 16. While grasping the open or closed states of the door glasses 21a, the power window ECU 18 controls the plurality of power window devices 16.

Further, the vehicle body 2 has a plurality of open-and-close sensors 22. The plurality of open-and-close sensors 22 are sensors that detect open or closed states of the plurality of doors 20. The plurality of open-and-close sensors 22 each output a signal indicating whether a corresponding door 20 is in an open state or in a closed state. Therefore, the signal outputted by each open-and-close sensor 22 includes door information indicating the open or closed state of a corresponding door.

The plurality of open-and-close sensors 22 are provided to the plurality of doors 20, respectively. When the vehicle body 2 has a hatch door, the open-and-close sensor 22 is also provided to the hatch door. The hatch door is a door that opens and closes together with the rear glass 21b.

The window glass 21 provided to each window that is open in the cabin 2a of the vehicle body 2 has a function of blocking a radio wave having a frequency in a predetermined band. More specifically, the window glass 21 has a function of blocking the radio wave transmitted from the feeding device 6.

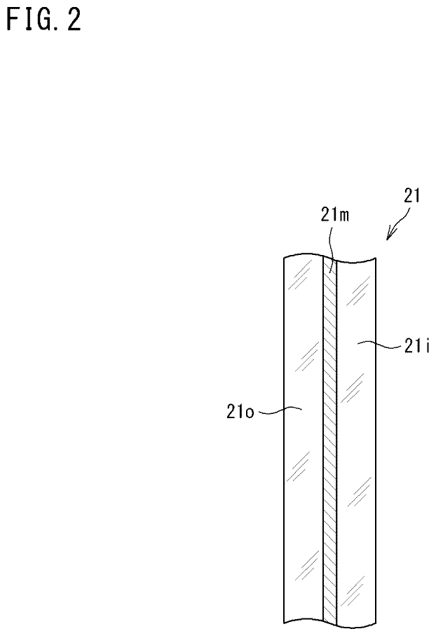

FIG. 2 is a cross-sectional view showing an example of the window glass 21.

As shown in FIG. 2, the window glass 21 has an outer glass part 21o, an inner glass part 21i, and a middle layer 21m.

The outer glass part 21o is disposed on the outer side of the vehicle body 2. The inner glass part 21i is disposed on the cabin 2a side.

The outer glass part 21o and the inner glass part 21i are each a known glass plate that allows visible light to pass therethrough.

The middle layer 21m is a layer composed of a shielding member having a property of blocking a radio wave having a frequency in a predetermined band. As the shielding member, a resin sheet including a metal mesh is used. In this case, the metal mesh is present between the outer glass part 21o and the inner glass part 21i. The radio wave is blocked by this metal mesh.

As the shielding member, a resin sheet having a conductive thin film provided in a predetermined pattern on the surface may also be used.

The window glass 21 of the present embodiment has the middle layer 21m, thereby blocking the radio wave transmitted from the feeding device 6.

Here, as described above, the cabin 2a of the vehicle body 2 is defined by the panels, the doors 20, and the plurality of window glasses 21.

Therefore, when the plurality of doors 20 and the door glasses 21a of the vehicle body 2 are in the closed state, the cabin 2a is surrounded by the window glasses 21 and the steel plates which are conductors. Accordingly, leakage of the radio wave of the feeding device 6 to the outside of the cabin 2a is inhibited.

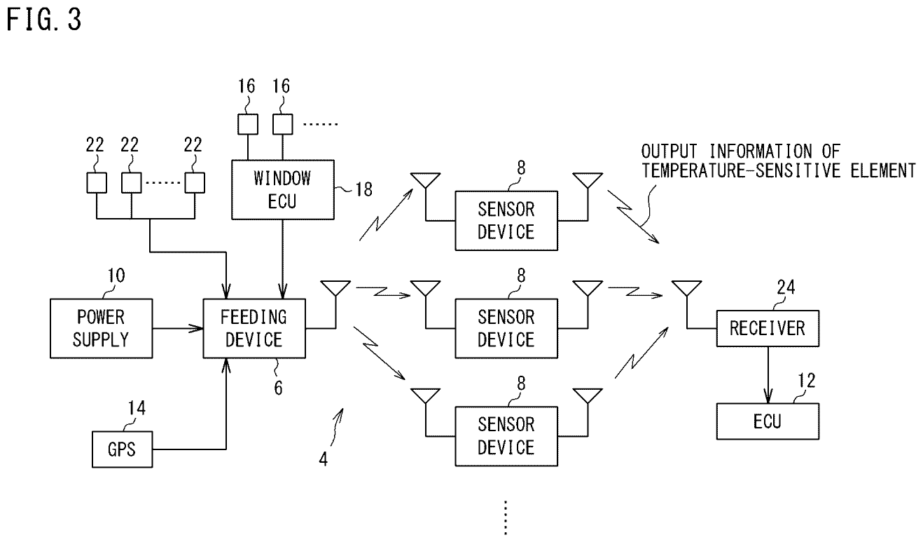

FIG. 3 shows a relationship between the wireless feeding system 4 and components of the vehicle 1.

As shown in FIG. 3, the power supply 10 is connected to the feeding device 6. The feeding device 6 is provided with power from the power supply 10. The power provided from the power supply 10 is used as the operating power of the feeding device 6 and also as the power to be fed to the plurality of sensor devices 8.

The GPS receiver 14, the power window ECU 18, and the plurality of open-and-close sensors 22 are also connected to the feeding device 6.

The GPS receiver 14 is communicably connected to the feeding device 6. The GPS receiver 14 transmits position information to the feeding device 6.

The power window ECU 18 is communicably connected to the feeding device 6. The power window ECU 18 transmits window information to the feeding device 6. The window information is information indicating the open or closed state of each door glass 21a.

The plurality of open-and-close sensors 22 are each connected so as to be able to output a signal toward the feeding device 6. As described above, the signal from each of the plurality of open-and-close sensors 22 includes door information. Therefore, the plurality of open-and-close sensors 22 transmit door information to the feeding device 6.

The feeding device 6 performs wireless feeding to each of the plurality of sensor devices 8 by transmitting a radio wave.

Using the power fed through the radio wave from the feeding device 6, the plurality of sensor devices 8 each perform temperature measurement in the cabin 2a and transmission of information (output information of the temperature-sensitive element) indicating the measurement result.

The vehicle body 2 further has a receiver 24 disposed in the cabin 2a. The receiver 24 receives information indicating the measurement results transmitted from the plurality of sensor devices 8, and provides the received information to the ECU 12.

The information indicating the measurement results provided from the plurality of sensor devices 8 is used, by the ECU 12, in control and the like of an air conditioner mounted on the vehicle body 2.

### Sensor Device 8

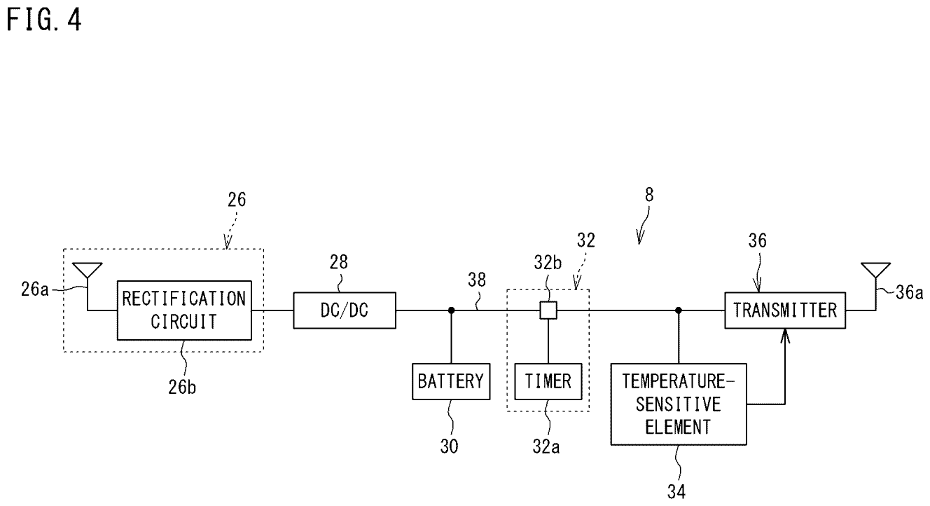

FIG. 4 is a block diagram showing a configuration example of the sensor device 8.

As shown in FIG. 4, the sensor device 8 includes a rectenna 26, a DC/DC converter 28, a battery 30, a timer 32, a temperature-sensitive element 34, and a transmitter 36.

The rectenna 26 has a reception antenna 26a and a rectification circuit 26b. The reception antenna 26a receives the radio wave from the feeding device 6. The reception antenna 26a provides an electric signal based on the received radio wave, to the rectification circuit 26b. The rectification circuit 26b rectifies the electric signal provided from the reception antenna 26a to convert the electric signal into direct-current power.

Thus, the rectenna 26 has a function of receiving the radio wave from the feeding device 6 and outputting direct-current power. That is, the rectenna 26 has a function of receiving power through the radio wave from the feeding device 6.

The direct-current power outputted by the rectenna 26 is provided to the DC/DC converter 28.

The DC/DC converter 28 converts the direct-current power outputted by the rectenna 26 so as to have a predetermined voltage. The DC/DC converter 28 provides the converted direct-current power having the predetermined voltage, to a line 38. The line 38 connects the DC/DC converter 28 and the transmitter 36 to each other. The line 38 has connected thereto the battery 30, the timer 32, and the temperature-sensitive element 34, in addition to the transmitter 36.

The battery 30 is connected between the DC/DC converter 28 and the transmitter 36. The battery 30 stores the direct-current power from the DC/DC converter 28.

The timer 32 has a timer unit 32a and a switch unit 32b. The switch unit 32b is connected in series to the line 38. The switch unit 32b is connected between the battery 30 and the temperature-sensitive element 34. The switch unit 32b performs switching between an ON state and an OFF state, based on a control signal provided from the timer unit 32a. The ON state is a state where the battery 30 side and the temperature-sensitive element 34 side are conductive with each other. The OFF state is a state where the battery 30 side and the temperature-sensitive element 34 side are not conductive with each other.

The timer unit 32a alternately switches the switch unit 32b between the ON state and the OFF state at a predetermined interval. When having maintained the switch unit 32b in the OFF state for 30 seconds, the timer unit 32a switches the switch unit 32b to the ON state. When having maintained the switch unit 32b in the ON state for 1 second, the timer unit 32a switches the switch unit 32b to the OFF state.

In this manner, the timer unit 32a switches the switch unit 32b from the OFF state to the ON state at an interval of 30 seconds.

The temperature-sensitive element 34 is a sensor that detects temperature which is a physical quantity in the cabin 2a. The temperature-sensitive element 34 is connected between the switch unit 32b and the transmitter 36. The temperature-sensitive element 34 is configured to include a thermistor, a thermocouple, or the like, for example. When having been provided with direct-current power from the DC/DC converter 28 or the battery 30, the temperature-sensitive element 34 provides an output corresponding to the present temperature of the temperature-sensitive element 34, to the transmitter 36. That is, the output from the temperature-sensitive element 34 indicates the result of measurement of the present temperature by the sensor device 8.

The transmitter 36 has a transmission antenna 36a, and has a function of performing wireless communication with the receiver 24 of the vehicle body 2. Between the transmitter 36 and the receiver 24, wireless communication is performed using Bluetooth (registered trademark), for example.

The transmitter 36 transmits output information indicating the output of the temperature-sensitive element 34, as information indicating the measurement result, toward the receiver 24 of the vehicle body 2.

When having been provided with direct-current power from the DC/DC converter 28 or the battery 30, the transmitter 36 establishes communication connection with the receiver 24. During this time, when having been provided with the output of the temperature-sensitive element 34, the transmitter 36 wirelessly transmits the output information of the temperature-sensitive element 34, to the receiver 24. When the output information of the temperature-sensitive element 34 has been received by the receiver 24, the output information is provided from the receiver 24 to the ECU 12.

Here, when having switched from the ON state to the OFF state, the switch unit 32b of the timer 32 switches from the OFF state to the ON state after an interval of 30 seconds.

In a case where the switch unit 32b is in the OFF state, direct-current power from the DC/DC converter 28 or the battery 30 is not provided to the temperature-sensitive element 34 and the transmitter 36. Thus, in this case, the output information of the temperature-sensitive element 34 is not wirelessly transmitted to the receiver 24.

On the other hand, in a case where the switch unit 32b is in the ON state, direct-current power from the DC/DC converter 28 or the battery 30 is provided to the temperature-sensitive element 34 and the transmitter 36. Thus, in this case, the temperature-sensitive element 34 provides an output to the transmitter 36, and the transmitter 36 wirelessly transmits the output information of the temperature-sensitive element 34 to the receiver 24.

Thus, the sensor device 8 wirelessly transmits the output information of the temperature-sensitive element 34 to the receiver 24 at an interval of 30 seconds.

Transmission (feeding) of the radio wave by the feeding device 6 may be restricted for a predetermined period as described later.

When the transmission of the radio wave by the feeding device 6 is restricted, no direct-current power is outputted from the DC/DC converter 28. Therefore, in this case, direct-current power stored in the battery 30 is provided to the temperature-sensitive element 34 and the transmitter 36. Accordingly, even when transmission of the radio wave by the feeding device 6 is restricted, operation of the temperature-sensitive element 34 and the transmitter 36 can be maintained by an amount corresponding to the power stored in the battery 30.

### Feeding Device 6

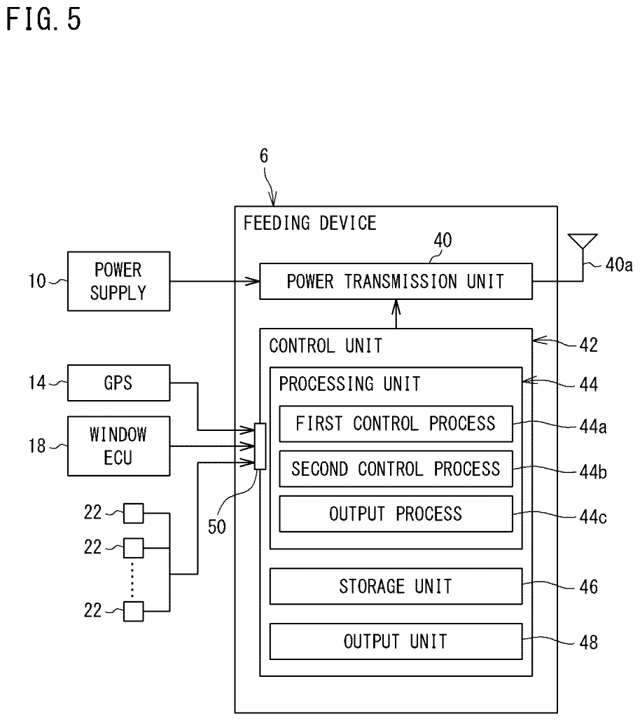

FIG. 5 is a block diagram showing a configuration example of the feeding device 6.

In FIG. 5, the feeding device 6 includes a power transmission unit 40 and a control unit 42.

The power transmission unit 40 generates a signal for feeding, based on power provided from the power supply 10, and transmits the signal, as a radio wave, from a power transmission antenna 40a. The power transmission antenna 40a of the present embodiment is nondirectional, and radiates a radio wave with a uniform gain toward the surroundings, without forming a beam or the like. The power transmission antenna 40a may have directivity.

The power transmission unit 40 of the present embodiment radiates a radio wave in a frequency band including 920 MHz. The frequency band of the radio wave radiated by the power transmission unit 40 is not particularly limited, but from the viewpoint of regulations and the like, may be a frequency band including 2.4 GHz or 5.7 GHz.

The control unit 42 is implemented by a computer or the like that includes a processing unit 44, a storage unit 46, an output unit 48, and a reception unit 50.

The processing unit 44 can be implemented by various types of processors suitable for control of a computer, such as a CPU (Central Processing Unit), a GPU (Graphics Processing Unit), a DSP (Digital Signal Processor), an FPGA (Field Programmable Gate Array), an ASIC (Application Specific Integrated Circuit), or a quantum processor, for example.

The storage unit 46 is a flash memory, a hard disk, a ROM (Read Only Memory), a RAM (Random Access Memory), or the like, for example.

In the storage unit 46, a computer program to be executed by the processing unit 44, necessary information, and the like are stored. The processing unit 44 executes a computer program stored in a computer-readable non-transitory storage medium such as the storage unit 46, thereby realizing various processing functions of the processing unit 44.

The output unit 48 has a function of outputting various types of information regarding processing performed by the processing unit 44, toward the outside. The output unit 48 may include a monitor, an indicator, and a speaker. In this case, the output unit 48 outputs various types of information through these devices. In addition, the output unit 48 may include a wireless communication device. In this case, the output unit 48 outputs various types of information through wireless communication.

The reception unit 50 is an interface for receiving various types of information from the GPS receiver 14, the power window ECU 18, and the plurality of open-and-close sensors 22. The control unit 42 receives, through the reception unit 50, position information from the GPS receiver 14, window information from the power window ECU 18, and door information from the plurality of open-and-close sensors 22. The position information, the window information, and the door information are information regarding the vehicle 1. That is, the reception unit 50 has a function of receiving information regarding the vehicle 1. The position information, the window information, and the door information are provided to the reception unit 50 at all times while the vehicle 1 is operating.

The processing unit 44 has a function of controlling the power transmission unit 40. The processing unit 44 has a function of executing a process (feeding control process) regarding control of feeding to the plurality of sensor devices 8.

The processing unit 44 stores the position information, the window information, and the door information received through the reception unit 50, into the storage unit 46 over time. The processing unit 44 can access pieces of information stored over time in the storage unit 46.

Further, the processing unit 44 has a function of executing a first control process 44a, a second control process 44b, and an output process 44c in the feeding control process.

The first control process 44a, the second control process 44b, and the output process 44c will be described in detail later.

### Process Performed by Processing Unit 44

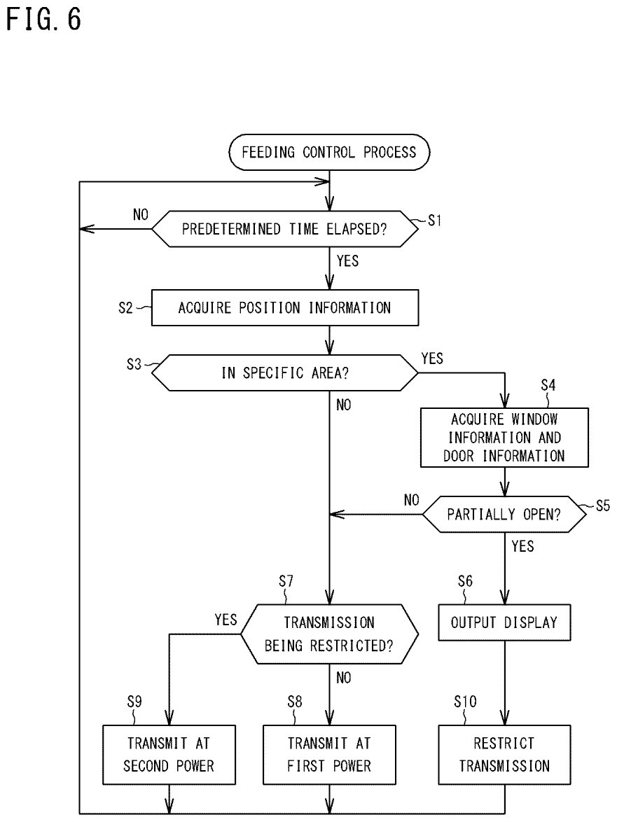

FIG. 6 is a flowchart showing an example of a feeding control process executed by the processing unit 44.

In FIG. 6, first, in step S1, the processing unit 44 determines whether or not a predetermined time has elapsed (step S1). This predetermined time is set in advance. In the feeding control process, every time a predetermined time has elapsed, determination as to whether or not to restrict feeding to the plurality of sensor devices 8 is performed.

The processing unit 44 repeats step S1 until determining that the predetermined time has elapsed.

In step S1, when having determined that the predetermined time has elapsed, the processing unit 44 advances to step S2, and acquires position information of the vehicle 1 provided from the GPS receiver 14 (step S2).

In step S2, upon acquiring the present position information of the vehicle 1, the processing unit 44 advances to step S3, and determines whether or not the present position of the vehicle 1 indicated by the present position information is in a specific area (step S3).

The specific area is an area set in advance, and is an area in which, when the radio wave from the feeding device 6 has leaked to the outside of the vehicle, there is a possibility that the leaked radio wave causes interference, disturbance, and the like to an external device, a facility, and the like.

More specifically, the external device, the facility, and the like include a radio astronomical observatory in which a radio telescope is installed, a tollgate of a toll road in which ETC (Electronic Toll Collection System) and DSRC (Dedicated Short Range Communications) are installed, and the like.

Therefore, the specific area includes the peripheral area including a radio astronomical observatory, and in addition, the peripheral area including a tollgate of a toll road in which ETC, DSRC, and the like are installed. The frequency band of a radio wave from space received by a radio telescope is several GHz to several 100 GHz. The frequency band of a radio wave used in ETC and DSRC is 5.775 to 5.845 GHZ.

The frequency band of the radio wave transmitted by the feeding device 6 includes 5.7 GHz as described above. Therefore, there is a possibility that the radio wave of the feeding device 6 causes interference, disturbance, and the like to a radio astronomical observatory, ETC, DSRC, and the like.

Therefore, at least the peripheral area including a radio astronomical observatory, and in addition, the peripheral area including a tollgate of a toll road in which ETC, DSRC, and the like are installed are set to be the specific area.

When having determined that the present position information is in the specific area in step S3, the processing unit 44 advances to step S4, and acquires window information and door information provided from the power window ECU 18 and the plurality of open-and-close sensors 22 (step S4).

When having acquired the present window information and the present door information in step S4, the processing unit 44 advances to step S5, and determines whether or not the window information and the door information indicate that at least either one of the door glasses 21a and the doors 20 is in the open state (step S5). In other words, the processing unit 44 determines whether or not all the door glasses 21a are in the closed state and all the doors 20 are in the closed state.

The open state of the door glasses 21a in step S5 includes a case where at least one of all the door glasses 21a is in the open state. Therefore, if one door glass 21a out of all the door glasses 21a is in the open state, the state of the door glasses 21a in step S5 is the open state. The open state is a state that is not the closed state. Therefore, if one door glass 21a is open even a little, the state of the one door glass 21a is the open state. This also applies to the doors 20, and if one door 20 is open even a little, the state of the one door 20 is the open state.

The open state of the doors 20 in step S5 includes a case where at least one of all the doors 20 is in the open state. Therefore, if one door 20 out of all the doors 20 is in the open state, the state of the doors 20 in step S5 is the open state.

When having determined that the window information and the door information indicate that at least either one of the door glasses 21a and the doors 20 is in the open state in step S5, the processing unit 44 advances to step S6.

In step S5, if the window information and the door information indicate that, out of all the door glasses 21a and all the doors 20, at least one door glass 21a or one door 20 is in the open state, the processing unit 44 advances to step S6.

In step S6, the processing unit 44 executes the output process 44c (FIG. 5). The output process 44c is a process of outputting, when it has been determined that the position information, the window information, and the door information, which are information regarding the vehicle 1, satisfy a predetermined condition, information indicating that the transmission of the radio wave is restricted.

In the output process 44c, the processing unit 44 may output information indicating that the present position of the vehicle 1 is in the specific area, or may output information indicating that the door glass 21a or the door 20 that is in the open state.

Here, the predetermined condition in the present embodiment is a condition determined in steps S3, S5 in FIG. 6, and includes Condition 1 and Condition 2 below.
Condition 1: the present position of the vehicle 1 indicated by the position information is in the specific area.
Condition 2: the window information and the door information indicate that at least either one of the door glasses 21a and the doors 20 is in the open state.

In step S6, the processing unit 44 outputs, to an occupant of the vehicle 1, information indicating that the above Condition 1 and Condition 2 are satisfied. The processing unit 44 outputs the information through the output unit 48. Accordingly, the information is outputted by a monitor, an indicator, a speaker, or the like.

When having executed the output process 44c in step S6, the processing unit 44 advances to step S10, controls the power transmission unit 40 so as to restrict transmission of the radio wave (step S10), and returns to step S1. In the present embodiment, restriction of transmission of the radio wave includes stopping the transmission of the radio wave. After restricting transmission of the radio wave performed by the power transmission unit 40, the processing unit 44 continues restriction of transmission of the radio wave in principle until performing control on the power transmission unit 40 thereafter.

Meanwhile, when having determined that the present position information is not in the specific area (outside the specific area) in step S3, the processing unit 44 advances to step S7, and determines whether or not transmission of the radio wave by the power transmission unit 40 is being restricted at present (step S7).

Also when having determined that the window information and the door information indicate that it is not the case where at least either one of the door glasses 21a and the doors 20 is in the open state (all the door glasses 21a are in the closed state and all the doors 20 are in the closed state) in step S5, the processing unit 44 advances to step S7.

When having determined, in step S7, that transmission of the radio wave is not being restricted at present, the processing unit 44 advances to step S8, causes the power transmission unit 40 to transmit the radio wave at first transmission power (step S8), and returns to step S1. Determination, in step S7, that transmission of the radio wave is not being restricted at present means that transmission of the radio wave was not restricted in the previous loop in the feeding control process. That is, here, the processing unit 44 determines that transmission of the radio wave is possible also in this loop, and performs transmission of the radio wave subsequently to the previous loop. The processing unit 44 causes the power transmission unit 40 to transmit the radio wave, whereby feeding to the plurality of sensor devices 8 is performed. After causing the power transmission unit 40 to transmit the radio wave at the first transmission power, the processing unit 44 continues transmission of the radio wave at the first transmission power in principle, until performing control on the power transmission unit 40 thereafter. Transmission of the radio wave here may be continuous transmission or may be intermittent transmission as long as the radio wave can be transmitted at the first transmission power.

The first transmission power is transmission power set in advance. The first transmitting power is set to a value larger than that of the transmission power used when transmission of the radio wave is restricted. That is, the first transmitting power is the transmitting power used when transmission of the radio wave is not restricted. In the present embodiment, as described above, restriction of transmission of the radio wave includes stopping the transmission of the radio wave. Therefore, the first transmitting power is set to a value larger than 0. In the present embodiment, the first transmission power is 1 W (watt), for example.

The first transmission power is set to a power value at which the battery 30 of the sensor device 8 can be maintained at an appropriate storage state.

Meanwhile, having determined, in step S7, that transmission of the radio wave is being restricted at present, the processing unit 44 advances to step S9, causes the power transmission unit 40 to transmit the radio wave at second transmission power (step S9), and returns to step S1. Determination, in step S7, that transmission of the radio wave is being restricted at present means that transmission of the radio wave was restricted in the previous loop in the feeding control process. That is, here, the processing unit 44 determines that, although having restricted transmission of the radio wave in the previous loop in the feeding control process, transmission of the radio wave is possible in this loop, and starts transmission of the radio wave. Such a situation occurs immediately after the vehicle 1 traveling with the window glass 21 open has come out of the specific area, for example.

The processing unit 44 causes the power transmission unit 40 to transmit the radio wave at the second transmission power in step S9, thereby canceling the restriction of transmission of the radio wave performed in the previous loop.

The second transmission power is transmission power set in advance, and is transmission power larger than the first transmission power. In the present embodiment, the second transmission power is 1.5 W (watt), for example.

After causing the power transmission unit 40 to transmit the radio wave at the second transmission power, the processing unit 44 continues transmission of the radio wave at the second transmission power in principle until performing control on the power transmission unit 40 thereafter.

The second transmission power is set to a power value at which the storage state of the storage battery having decreased due to the restriction of transmission of the radio wave can be recovered to an appropriate state.

As described above, the processing unit 44 repeatedly executes the process shown in the flowchart in FIG. 6, thereby performing the determination as to whether or not to restrict feeding to the plurality of sensor devices 8, every predetermined time.

The processing unit 44 of the present embodiment has a function of executing the first control process 44a (FIG. 5) as described above.

The first control process 44a is a process (step S10) of restricting transmission of the radio wave performed by the power transmission unit 40, when it has been determined that the position information, the window information, and the door information, which are information regarding the vehicle 1, satisfy the predetermined condition (Condition 1 and Condition 2) (steps S3, S5).

In the present embodiment, the predetermined condition includes Condition 1 above, and thus, when the vehicle 1 is positioned in an area where there is a possibility of causing interference, disturbance, and the like to an external device, a facility, and the like such as a radio astronomical observatory, ETC, and DSRC, transmission of the radio wave can be restricted. Accordingly, it is possible to inhibit the radio wave for feeding from influencing an external device, a facility, and the like.

In the present embodiment, the window glass 21 of the vehicle body 2 has the glass parts 21o, 21i and the middle layer 21m composed of a shielding member. Thus, if all the door glasses 21a and all the doors 20 are in the closed state, leakage of the radio wave of the feeding device 6 to the outside of the vehicle can be inhibited.

Therefore, even when the vehicle 1 is positioned in the specific area, if all the door glasses 21a and all the doors 20 are in the closed state, the processing unit 44 performs wireless feeding (steps S3, 4, 5, 8, 9).

Meanwhile, the predetermined condition includes Condition 2 above, and thus, when there is a possibility that the radio wave of the feeding device 6 leaks to the outside of the vehicle since the door glass 21a or the door 20 of the vehicle 1 is in the open state, transmission of the radio wave can be restricted. Accordingly, it is possible to inhibit the radio wave for feeding from influencing an external device, a facility, and the like.

Thus, according to the present embodiment, through execution of the first control process 44a, when there is a possibility that the radio wave of the power transmission unit 40 leaks to the outside of the vehicle or causes interference, disturbance, and the like to an external device, a facility, and the like, transmission of the radio wave can be restricted.

As a result, it is possible to inhibit the radio wave for feeding from influencing an external device, a facility, and the like.

According to the present embodiment, since the processing unit 44 executes the output process 44c in step S6, it is possible to notify the occupant of the vehicle 1 that transmission of the radio wave is to be restricted.

The processing unit 44 of the present embodiment has a function of executing the second control process 44b (FIG. 5) as described above.

The second control process 44b is a process in which: when it has been determined that the position information, the window information, and the door information, which are information regarding the vehicle 1, do not satisfy either one of Condition 1 and Condition 2, it is determined whether or not transmission of the radio wave by the power transmission unit 40 is being restricted (step S7); when it has been determined that transmission of the radio wave is not being restricted, the radio wave is transmitted at the first transmission power (step S8); and when it has been determined that transmission of the radio wave is being restricted, the radio wave is transmitted at the second transmission power to cancel the restriction of transmission of the radio wave (step S9).

In this case, after transmission of the radio wave has been restricted, when there is no longer a possibility that the radio wave of the feeding device 6 leaks to the outside of the vehicle or causes interference, disturbance, and the like to an external device, a facility, and the like, feeding is performed at the second transmission power larger than the first transmission power. Thus, supply power to the sensor device 8 having decreased due to restriction of transmission of the radio wave can be supplemented.

That is, the first transmission power is set to a power value at which the battery 30 can be maintained in an appropriate storage state, and the processing unit 44 performs feeding at the second transmission power larger than the first transmission power.

Therefore, in the sensor device 8, even if the storage state of the battery 30 has largely decreased due to restriction of transmission (feeding) of the radio wave of the feeding device 6, recovery of the storage state is quickly performed through feeding based on the second transmission power thereafter.

### Second Embodiment

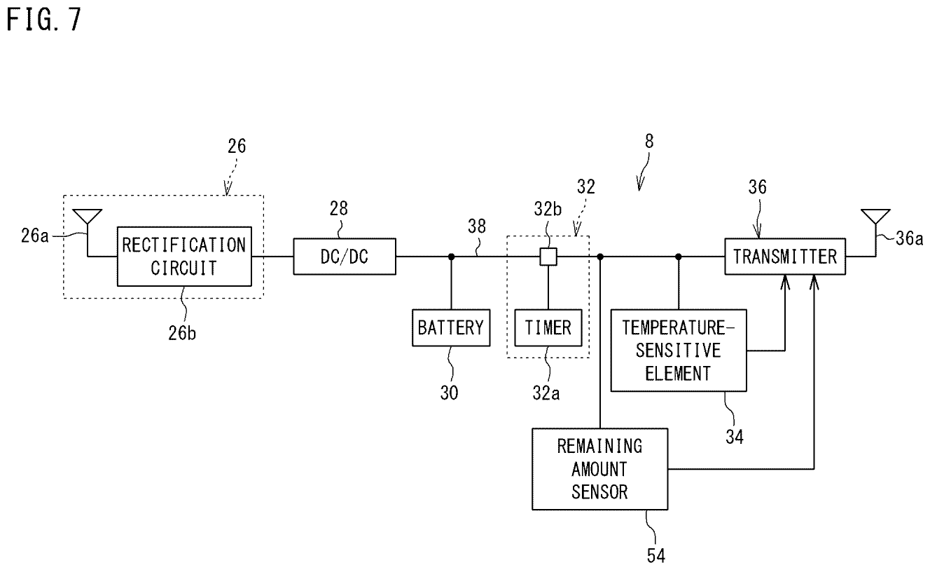

FIG. 7 is a block diagram of the sensor device 8 according to a second embodiment.

The present embodiment is different from the first embodiment in that: the sensor device 8 further includes a remaining amount sensor 54 that detects the storage state of the battery 30, and transmits power storage information indicating the storage state to the outside; and the processing unit 44 is configured to adjust the second transmission power, based on the power storage information.

The other configurations are the same as those of the first embodiment.

In FIG. 7, the remaining amount sensor 54 is connected between the switch unit 32b and the temperature-sensitive element 34. The remaining amount sensor 54 is a voltage sensor configured to include a voltage-dividing resistor and the like, for example.

The remaining amount sensor 54 outputs, as the storage state of the battery 30, the voltage of the line 38 when direct-current power is provided from the DC/DC converter 28 or the battery 30.

Here, the voltage of the line 38 when power is supplied only from the battery 30 changes in accordance with the remaining power amount stored in the battery 30. Therefore, the output of the remaining amount sensor 54 when power is supplied only from the battery 30 indicates the remaining power amount stored in the battery 30. That is, the storage state of the battery 30 indicates the remaining power amount stored in the battery 30.

The output of the remaining amount sensor 54 is provided to the transmitter 36.

The transmitter 36 transmits output information indicating the output of the remaining amount sensor 54 and output information of the temperature-sensitive element 34, toward the receiver 24 (the ECU 12) of the vehicle body 2.

Accordingly, when the switch unit 32b is in the ON state, direct-current power from the DC/DC converter 28 or the battery 30 is provided to the remaining amount sensor 54, the temperature-sensitive element 34, and the transmitter 36. Thus, in this case, the remaining amount sensor 54 and the temperature-sensitive element 34 each provide an output to the transmitter 36. The transmitter 36 wirelessly transmits the output information of the remaining amount sensor 54 and the output information of the temperature-sensitive element 34 to the receiver 24.

When there is no transmission (feeding) of the radio wave from the feeding device 6 and direct-current power is provided to each component only from the battery 30, the output information of the remaining amount sensor 54 is transmitted, as the power storage information of the battery 30, to the receiver 24.

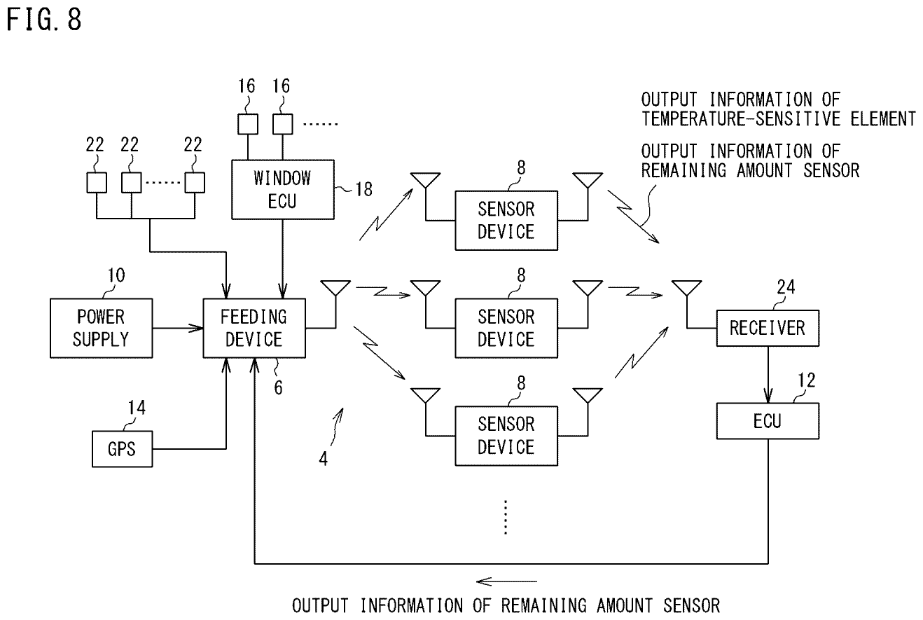

As shown in FIG. 8, the output information of the remaining amount sensor 54 and the output information of the temperature-sensitive element 34, which have been transmitted by (the transmitter 36 of) the sensor device 8, are received by the receiver 24 of the vehicle body 2.

The receiver 24 provides the received information to the ECU 12.

The ECU 12 provides the output information of the remaining amount sensor 54 to the reception unit 50 of the feeding device 6. Accordingly, the processing unit 44 of the feeding device 6 can acquire the output information of the remaining amount sensor 54.

The processing unit 44 stores the output information of the remaining amount sensor 54 into the storage unit 46 over time. The processing unit 44 can access the output information of the remaining amount sensor 54 stored over time in the storage unit 46.

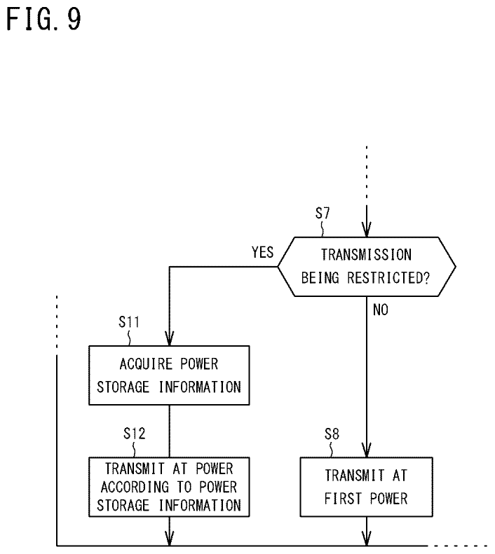

FIG. 9 is a flowchart showing a feeding control process executed by the processing unit 44 according to the second embodiment. FIG. 9 shows the portion different from the flowchart shown in FIG. 6. More specifically, step S9 in FIG. 6 is replaced by steps S11, S12 in FIG. 9. The other portions are the same between the flowchart in FIG. 6 and the flowchart in FIG. 9. Here, only the different part will be described.

In FIG. 9, when having determined, in step S7, that transmission of the radio wave is being restricted at present, the processing unit 44 advances to step S11 and acquires output information of the remaining amount sensor 54 (step S11).

Here, the processing unit 44 acquires the output information of the remaining amount sensor 54 at the present time point at which transmission of the radio wave is restricted. The output information of the remaining amount sensor 54 transmitted when transmission (feeding) of the radio wave by the feeding device 6 is restricted indicates the power storage information of the battery 30. Accordingly, the processing unit 44 can acquire the power storage information of the battery 30.

When having acquired the power storage information of the battery 30, the processing unit 44 advances to step S12, adjusts the second transmission power in accordance with the power storage information, then, causes the power transmission unit 40 to transmit the radio wave (step S12), and returns to step S1.

In step S12, the second transmission power is selected from either one of a first power value and a second power value. The first power value is a value larger than the first transmission power. The second power value is a value larger than the first power value.

The processing unit 44 compares a threshold set in advance with the value (the value indicating the voltage of the line 38) indicated by the power storage information.

When the value of the power storage information is larger than the threshold, the processing unit 44 selects the first power value as the value for the second transmission power, and causes the power transmission unit 40 to transmit the radio wave at the first power value.

When the value of the power storage information is equal to or smaller than the threshold, the processing unit 44 selects the second power value as the value for the second transmission power, and causes the power transmission unit 40 to transmit the radio wave at the second power value.

Thus, in a case where it is possible to determine that the storage state of the battery 30 is more decreased since the value of the power storage information is equal to or smaller than the threshold, the processing unit 44 feeds more power toward the plurality of sensor devices 8, thereby being able to more quickly supplement the supply power to the sensor devices 8.

Thus, in the present embodiment, since the second transmission power is adjusted based on the power storage information, feeding can be appropriately performed in accordance with the storage state of the battery 30.

The transmitter 36 of the sensor device 8 of the present embodiment transmits the output information of the remaining amount sensor 54 and the output information of the temperature-sensitive element 34 toward the receiver 24 of the vehicle body 2. Therefore, it is not necessary to prepare a plurality of transmission devices in order to transmit both pieces of information, whereby a simple configuration can be realized.

### Others

The embodiments disclosed herein are merely illustrative and not restrictive in all aspects.

For example, in the above embodiments, a case where the GPS receiver 14, the power window ECU 18, and the plurality of open-and-close sensors 22 are connected to the feeding device 6, and the position information, the window information, and the door information are received by the reception unit 50 of the control unit 42, has been shown as an example.

However, in a case where the GPS receiver 14, the power window ECU 18, and the plurality of open-and-close sensors 22 are connected to the ECU 12 via a network in the vehicle (or in-vehicle network), and the position information, the window information, and the door information are aggregated by the ECU 12, the control unit 42 may be configured to acquire the position information, the window information, and the door information from the ECU 12.

In this case, the reception unit 50 of the control unit 42 is configured as an interface for the vehicle network.

In the above embodiments, a case where the window glass 21 has the glass parts 21o, 21i, and the middle layer 21m composed of a shielding member, has been shown as an example. However, a window glass may be configured to have a glass part and a shielding film stacked on the surface of the glass part. The shielding film has a property of blocking a radio wave having a frequency in a predetermined band. The shielding film has a conductive thin film provided in a predetermined pattern on the surface, and the radio wave having a frequency in the predetermined band is blocked by this conductive thin film.

In the above embodiments, a case where, when Condition 1 and Condition 2 described above are satisfied in the feeding control process, transmission of the radio wave is restricted, has been shown as an example. However, the system may be configured such that transmission of the radio wave is restricted if only Condition 1 is satisfied irrespective of Condition 2. Alternatively, the system may be configured such that transmission of the radio wave is restricted if only Condition 2 is satisfied irrespective of Condition 1.

In a case where transmission of the radio wave is restricted when only Condition 1 is satisfied, if the present position of the vehicle 1 is in the specific area, transmission of the radio wave is always restricted. Therefore, it is not necessary to block the radio wave in order to inhibit leakage of the radio wave of the feeding device 6. Thus, each panel forming the body part 100 may be formed from resin, or the window glass 21 need not necessarily include the middle layer 21m.

In a case where the system is configured such that transmission of the radio wave is restricted when Condition 2 is satisfied, and transmission is not restricted when Condition 2 is not satisfied, each panel and window glass 21 forming the body part 100 need to have a function of blocking the radio wave in order to inhibit leakage of the radio wave. In this case, each panel forming the body part 100 may be formed from a conductor, as in the above embodiments, or may be formed from a resin including a member for blocking the radio wave such as a conductor.

In addition, a case where restriction of transmission of the radio wave in step S10 (FIG. 6) in the above embodiments includes stopping the transmission of the radio wave has been shown. However, restriction of transmission of the radio wave may include decreasing the transmission power to an extent that does not influence the surroundings.

In addition, in step S7 (FIG. 6) of the above embodiments, a case where it is determined whether or not transmission of the radio wave by the power transmission unit 40 is being restricted at present, has been shown as an example. However, it may be determined whether or not transmission of the radio wave was restricted for a predetermined period in the past from the present. In this case, the period in which the radio wave is transmitted at the second transmission power can be made longer, and thus, supplementation of the supply power to the sensor device 8 can be more effectively performed.

In the above embodiments, a case where the sensor device 8 is configured to wirelessly transmit the output information of the temperature-sensitive element 34 to the receiver 24 at an interval of 30 seconds has been shown as an example.

In contrast, the sensor device 8 may be configured to include a remaining amount sensor that detects the storage state of the battery 30, and a control unit that adjusts the switching timing between the ON state and the OFF state of the timer 32 in accordance with the storage state. In this case, when the value indicating the storage state is smaller than a predetermined value, it is possible to cause the control unit to adjust the interval at which the output information of the temperature-sensitive element 34 is wirelessly transmitted, to a time interval longer than 30 seconds. Accordingly, the power consumed by wirelessly transmitting the output information of the temperature-sensitive element 34 can be suppressed, and decrease of the storage state of the battery 30 can be suppressed.

In the above embodiments, a case where the sensor device 8 includes the temperature-sensitive element 34 has been shown as an example. However, the sensor device 8 may include another sensor element instead of the temperature-sensitive element 34 or in addition to the temperature-sensitive element 34. Examples of the other sensor element include sensor elements that detect illuminance, acceleration, angle, strain, vibration, sound, odor, and the like.

For example, a sensor device 8 that includes a sensor element that detects strain is provided to a headrest of a seat, and the like. The sensor device 8 provided to the headrest can output a signal that allows detection as to whether or not an occupant is present on the seat. Due to the output of this sensor device 8, the processing unit 44 can grasp the presence or absence of an occupant at each seat, and can appropriately adjust the air volume and the orientation of the air conditioner in the vehicle body 2.

In the above embodiments, a case where the vehicle 1 is a passenger car has been shown as an example. However, the vehicle 1 may be a bus or a truck. When the vehicle 1 is a freezer car or a refrigerator car, the temperature distribution in the cargo compartment can be measured by a plurality of sensor devices 8. In the case of a freezer car or a refrigerator car, temperature management and recording of individual cargoes may be required. However, a sensor using a replacement-type dry battery or the like requires work of battery replacement. In contrast, in the case of wireless feeding as in the present embodiment, battery replacement is not required.

The processing unit 44 performs feeding control in accordance with whether the door of the cargo compartment is open or closed. Accordingly, it is possible to inhibit the radio wave for feeding from influencing an external device, a facility, and the like.

The scope of the present disclosure is defined by the scope of the claims rather than the meaning described above, and is intended to include meaning equivalent to the scope of the claims and all modifications within the scope.

1. A wireless feeding system comprising:
a power receiving device disposed in a vehicle; and
a feeding device configured to feed power through a radio wave to the power receiving device, wherein
the feeding device includes
a power transmission unit disposed in the vehicle and configured to transmit the radio wave, and
a control unit configured to control the power transmission unit, and
the control unit includes
a reception unit configured to receive information regarding the vehicle, and
a processing unit configured to execute a first control process of restricting transmission of the radio wave, when having determined that the information satisfies a predetermined condition.

2. The wireless feeding system according to claim 1, wherein the information includes position information of the vehicle.

3. The wireless feeding system according to claim 2, wherein the predetermined condition includes that a position of the vehicle indicated by the position information is in a specific area set in advance.

4. The wireless feeding system according to claim 1, wherein
the vehicle includes a body part that has: a plurality of panels each composed of a conductor; and a window glass including a glass part and a shielding member configured to block the radio wave, and
the information includes at least one of window information indicating an open or closed state of the window glass, and door information indicating an open or closed state of a door of the vehicle.

5. The wireless feeding system according to claim 4, wherein the predetermined condition includes that the window information and the door information indicate that at least one of the window glass and the door is in an open state.

6. The wireless feeding system according to claim 1, wherein the processing unit further executes an output process of outputting information indicating that transmission of the radio wave is restricted when the information satisfies the predetermined condition.

7. The wireless feeding system according to claim 1, wherein
the processing unit
when having determined that the information does not satisfy the predetermined condition, determines whether or not transmission of the radio wave is being restricted,
when having determined that transmission of the radio wave is not being restricted, transmits the radio wave at first transmission power larger than transmission power of the radio wave restricted by the first control process, and
when having determined that transmission of the radio wave is being restricted, further executes a second control process of transmitting the radio wave at second transmission power larger than the first transmission power to cancel restriction of transmission of the radio wave.

8. The wireless feeding system according to claim 7, wherein
the power receiving device includes:
a storage battery configured to store transmission power from the feeding device; and
a transmitting unit configured to transmit power storage information indicating a storage state of the storage battery,
the reception unit of the feeding device further receives the power storage information, and
in the second control process, the second transmission power is adjusted based on the power storage information.

9. The wireless feeding system according to claim 8, wherein
the power receiving device further includes a sensor configured to detect a physical quantity in the vehicle,
the transmitting unit transmits output information of the sensor together with the power storage information to the vehicle, and
the reception unit receives the power storage information provided from the vehicle.

10. A wireless feeding device configured to feed power through a radio wave to a power receiving device disposed in a vehicle, the wireless feeding device comprising:
a power transmission unit disposed in the vehicle and configured to transmit the radio wave; and
a control unit configured to control the power transmission unit, wherein
the control unit includes
a reception unit configured to receive information regarding the vehicle, and
a processing unit configured to execute a first control process of restricting transmission of the radio wave, when having determined that the information satisfies a predetermined condition.

11. A control device configured to control a power transmission unit of a wireless feeding device configured to feed power through a radio wave to a power receiving device disposed in a vehicle, the control device comprising:
a reception unit configured to receive information regarding the vehicle; and
a processing unit configured to execute a first control process of restricting transmission of the radio wave, when having determined that the information satisfies a predetermined condition.

12. A vehicle comprising:
a vehicle body;
a power receiving device disposed in the vehicle body; and
a feeding device configured to feed power through a radio wave to the power receiving device, wherein
the feeding device includes
a power transmission unit disposed in the vehicle and configured to transmit the radio wave, and
a control unit configured to control the power transmission unit, and
the control unit includes
a reception unit configured to receive information regarding the vehicle, and
a processing unit configured to execute a first control process of restricting transmission of the radio wave, when having determined that the information satisfies a predetermined condition.

13. A wireless feeding method for feeding power through a radio wave to a power receiving device disposed in a vehicle, the wireless feeding method comprising the steps of:
receiving information regarding the vehicle; and
restricting transmission of the radio wave, when having determined that the information satisfies a predetermined condition.
